(19) United States
(12) Patent Application Publication
(10) Pub. No.: US 2026/0184642 A1
(43) Pub. Date: Jul. 2, 2026

(54) CUBIC BORON NITRIDE SINTERED BODY, COATED CUBIC BORON NITRIDE SINTERED BODY, AND TOOL HAVING SAME

(71) Applicant: TUNGALOY CORPORATION, Fukushima (JP)

(72) Inventor: Takeru SAKAMOTO, Iwaki-shi (JP)

(73) Assignee: TUNGALOY CORPORATION, Fukushima (JP)

(21) Appl. No.: 19/420,382

(22) Filed: Dec. 15, 2025

(30) Foreign Application Priority Data
Dec. 27, 2024 (JP) 2024-232531

(51) Int. Cl. C04B 35/5831; C04B 41/85

(52) U.S. Cl. CPC C04B 35/5831; C04B 41/85; C04B 2235/386; C04B 2235/762; C04B 2235/785; C04B 2235/786

(57) ABSTRACT

An object of the present invention is to provide a cubic boron nitride sintered body and a coated cubic boron nitride sintered body both having excellent wear resistance and fracture resistance and being capable of extending a tool life, and a tool having the same.

A cubic boron nitride sintered body containing cubic boron nitride and a binder phase, in which in a cross-sectional structure, content ratios of the cubic boron nitride and the binder phase fall within specific ranges, the binder phase includes an Al compound phase containing a specific compound and a Ti compound phase containing a specific compound, the Ti compound phase includes a composite compound phase containing a specific compound, a content ratio of the Al compound phase and a content ratio of the Ti compound phase based on a whole of the binder phase fall within specific ranges, and in a range from the interface between the cubic boron nitride and the binder phase to a distance of 300 nm toward the binder phase, a content ratio X2 of the composite compound phase based on a whole of the binder phase is larger than a content ratio X1 of the composite compound phase based on a whole of the binder phase.

### BACKGROUND OF THE INVENTION

### Field of the Invention

The present invention relates to a cubic boron nitride sintered body, a coated cubic boron nitride sintered body, and a tool having the same.

### Description of Related Art

A cubic boron nitride sintered body contains cubic boron nitride and a binder phase. Conventionally, as tools for which a cubic boron nitride sintered body for cutting an iron-based work material such as steel or cast iron is used, cubic boron nitride sintered bodies containing a Ti compound as a material of a binder phase have been in wide use. This is because the cubic boron nitride sintered body containing a Ti compound has a poor affinity to iron-based work materials and excellent reactive wear resistance.

### SUMMARY

### Technical Problem

However, conventional cubic boron nitride sintered bodies containing a Ti compound have a problem in that the thermal conductivity and the toughness are low.

In addition, recently, the speeds, feed rates, and cutting depths of cutting processes have increased more significantly, and there is a demand for improving the thermal shock resistance of tools more than ever. Particularly, in recent years, in the case of using a coolant in the intermittent cutting process of carburized and quenched steel, the cutting temperature has abruptly changed. Under such severe cutting conditions, thermal shock-induced chipping is liable to occur in conventional tools, which creates a problem in that cutting tools fracture and thereby the tool life cannot be prolonged.

In such a background, WO 2021/010476 discloses a cubic boron nitride sintered body having a long tool life even in the high-efficiency processing of high-strength hardened steel since a binder phase contains first binder particles containing a compound composed of titanium and a predetermined element and second binder particles. However, since the binder phase described in WO 2021/010476 contains the second binder particles, the thermal conductivity of the cubic boron nitride sintered body decreases, the thermal shock resistance is not sufficient in processing in which the cutting temperature abruptly changes, and there is room for improvement in fracture resistance.

An object of the present invention is to provide a cubic boron nitride sintered body and a coated cubic boron nitride sintered body both having excellent wear resistance and fracture resistance and being capable of extending the tool life, and a tool having the same.

### Solution to Problem

The present inventors repeated studies on the extension of tool life, consequently found that in a cubic boron nitride sintered body containing a Ti compound, when, among Ti compound phases, a composite compound phase having excellent toughness but poor thermal conductivity is unevenly distributed in the vicinities of the surfaces of cubic boron nitride particles having excellent thermal conductivity, it becomes possible to improve the toughness of the cubic boron nitride sintered body without degrading the thermal shock resistance, and as a result, the tool life can be extended, and completed the present invention.
<1> A cubic boron nitride sintered body comprising: cubic boron nitride and a binder phase,
wherein when a cross-sectional structure of the cubic boron nitride sintered body is observed, a content ratio of the cubic boron nitride is 10.0 area % or more and 60.0 area % or less, and a content ratio of the binder phase is 40.0 area % or more and 90.0 area % or less, based on 100 area % in total of the cubic boron nitride sintered body,
the binder phase comprises an Al compound phase and a Ti compound phase,
the Al compound phase comprises a compound of Al and at least one element selected from the group consisting of C, N, O, and B,
the Ti compound phase comprises at least one selected from the group consisting of a compound of Ti and at least one element selected from the group consisting of C, N, O, and B and a compound of Ti, at least one element selected from the group consisting of V, Cr, Zr, Nb, Mo, Hf, Ta, and W, and at least one element selected from the group consisting of C, N, O, and B,
the Ti compound phase comprises a composite compound phase,
the composite compound phase comprises at least one selected from the group consisting of a carbide, a nitride, and a carbonitride each comprising Ti and at least one element selected from the group consisting of V, Cr, Zr, Nb, Mo, Hf, Ta, and W,
in the cross-sectional structure, a content ratio of the Al compound phase is more than 0.0 area % and 20.0 area % or less, and a content ratio of the Ti compound phase is 80.0 area % or more and less than 100.0 area %, based on 100 area % in total of the binder phase, and
in the cross-sectional structure, when a content ratio of the composite compound phase based on 100 area % in total of the binder phase is indicated by a content ratio X1, and a content ratio of the composite compound phase based on 100 area % in total of the binder phase in a range from an interface between the cubic boron nitride and the binder phase to a distance of 300 nm toward the binder phase is indicated by a content ratio X2, the content ratio X2 is larger than the content ratio X1.
<2> The cubic boron nitride sintered body according to <1>, wherein a ratio of the content ratio X2 to the content ratio X1 is 1.10 or more and 2.10 or less.
<3> The cubic boron nitride sintered body according to <1> or <2>, wherein the content ratio X1 is 2.0 area % or more and 30.0 area % or less.
<4> The cubic boron nitride sintered body according to any one of <1> to <3>, wherein an average grain size of the composite compound phase is 0.8 μm or more and 3.0 μm or less.
<5> The cubic boron nitride sintered body according to any one of <1> to <4>, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.
<6> The cubic boron nitride sintered body according to any one of <1> to <5>, wherein the content ratio X2 is 3.0 area % or more and 45.0 area % or less.
<7> A coated cubic boron nitride sintered body including: the cubic boron nitride sintered body according to any one of <1> to <6>; and a coating layer formed on a surface of the cubic boron nitride sintered body,
wherein the coating layer is a single layer or a lamination of two or more layers comprising at least one element selected from the group consisting of Ti, Zr, Hf, V, Nb, Ta, Cr, Mo, W, Al, and Si and at least one element selected from the group consisting of C, N, O, and B, and
an average thickness of a whole of the coating layer is 0.5 μm or more and 8.0 μm or less.
<8> A tool including: the cubic boron nitride sintered body according to any one of <1> to <6>.
<9> A tool including: the coated cubic boron nitride sintered body according to <7>.

### Advantageous Effects of Invention

According to the present invention, it is possible to provide a cubic boron nitride sintered body and a coated cubic boron nitride sintered body both having excellent wear resistance and fracture resistance and being capable of extending the tool life, and a tool having the same.

### DETAILED DESCRIPTION

Hereinafter, embodiments for carrying out the present invention (hereinafter simply referred to as “the present embodiment”) will be described in detail, but the present invention is not limited to the present embodiment below. The present invention can be modified in various manners without departing from the gist thereof.

### [Cubic Boron Nitride Sintered Body]

A cubic boron nitride sintered body (hereinafter, cubic boron nitride will be referred to as “cBN” in some cases) according to the present embodiment is a cBN sintered body containing a cBN and a binder phase, in which when a cross-sectional structure of the cBN sintered body is observed, a content ratio of the cBN is 10.0 area % or more and 60.0 area % or less, and a content ratio of the binder phase is 40.0 area % or more and 90.0 area % or less, based on 100 area % in total of the cBN sintered body, the binder phase contains an Al compound phase and a Ti compound phase, the Al compound phase contains a compound of Al and at least one element selected from the group consisting of C, N, O, and B, the Ti compound phase contains at least one selected from the group consisting of a compound of Ti and at least one element selected from the group consisting of C, N, O, and B and a compound of Ti, at least one element selected from the group consisting of V, Cr, Zr, Nb, Mo, Hf, Ta, and W, and at least one element selected from the group consisting of C, N, O, and B, the Ti compound phase contains a composite compound phase, the composite compound phase contains at least one selected from the group consisting of a carbide, a nitride, and a carbonitride each containing Ti and at least one element selected from the group consisting of V, Cr, Zr, Nb, Mo, Hf, Ta, and W, in the cross-sectional structure, a content ratio of the Al compound phase is more than 0.0 area % and 20.0 area % or less, and a content ratio of the Ti compound phase is 80.0 area % or more and less than 100.0 area %, based on 100 area % in total of the binder phase, and in the cross-sectional structure, when a content ratio of the composite compound phase based on 100 area % in total of the binder phase is indicated by a content ratio X1, and the content ratio of the composite compound phase based on 100 area % in total of the binder phase in a range from the interface between cBN and the binder phase to a distance of 300 nm toward the binder phase is indicated by a content ratio X2, the content ratio X2 is larger than the content ratio X1.

When the cBN sintered body of the present embodiment is configured as described above, it becomes possible to improve wear resistance and fracture resistance, and as a result, the tool life can be extended.

The reason for the cBN sintered body of the present embodiment having improved wear resistance and fracture resistance and having a long tool life is not clear in detail, but the present inventors infer the reason as follows. However, the reason is not limited thereto.

In the cBN sintered body of the present embodiment, when the cross-sectional structure of the cBN sintered body is observed, the content ratio of the cBN is 10.0 area % or more based on 100 area % in total of the cBN sintered body, whereby the content ratio of the cBN having excellent mechanical strength increases, and the cBN sintered body is thus mainly excellent in fracture resistance. On the other hand, in the cBN sintered body of the present embodiment, the content ratio of the cBN is 60.0 area % or less, whereby the content ratio of the cBN, which is poor in reaction resistance with iron, is low, and the cBN sintered body is thus mainly excellent in wear resistance.

When the cross-sectional structure of the cBN sintered body is observed, the content ratio of the binder phase is 40.0 area % or more based on 100 area % in total of the cBN sintered body, whereby the content ratio of the cBN, which is poor in reaction resistance with iron, becomes relatively low, and the cBN sintered body of the present embodiment is thus mainly excellent in wear resistance, On the other hand, the content ratio of the binder phase is 90.0 area % or less, whereby the content ratio of the cBN, which is excellent in mechanical strength, becomes relatively high, and the cBN sintered body of the present embodiment is thus mainly excellent in fracture resistance.

The Al compound phase contains a compound of Al and at least one element selected from the group consisting of C, N, O, and B, and when the cross-sectional structure of the cBN sintered body is observed, the content ratio of the Al compound phase is more than 0.0 area % base on 100 area % in total of the binder phase, whereby the sinterability of the cBN sintered body improves, and the cBN sintered body of the present embodiment is thus mainly excellent in fracture resistance. On the other hand, the content ratio of the Al compound phase is 20.0 area % or less, whereby the formation of a coarse Al compound is curbed, and chipping resistance improves, and the cBN sintered body of the present embodiment is thus mainly excellent in fracture resistance.

The Ti compound phase contains at least one selected from the group consisting of a compound of Ti and at least one element selected from the group consisting of C, N, O, and B and a compound of Ti, at least one element selected from the group consisting of V, Cr, Zr, Nb, Mo, Hf, Ta, and W, and at least one element selected from the group consisting of C, N, O, and B, and when the cross-sectional structure of the cBN sintered body is observed, the content ratio of the Ti compound phase is 80.0 area % or more based on 100 area % in total of the binder phase, whereby the reaction resistance with iron improves, and the cBN sintered body of the present embodiment is thus mainly excellent in wear resistance. On the other hand, the content ratio of the Ti compound phase is less than 100.0 area %, whereby the toughness improves, and the cBN sintered body of the present embodiment is thus mainly excellent in fracture resistance.

The Ti compound phase contains the composite compound phase, and the composite compound phase contains at least one selected from the group consisting of a carbide, a nitride, and a carbonitride each containing Ti and at least one element selected from the group consisting of V, Cr, Zr, Nb, Mo, Hf, Ta, and W, whereby the toughness improves, and the cBN sintered body of the present embodiment is thus mainly excellent in fracture resistance.

When the cross-sectional structure of the cBN sintered body is observed, in a case where the content ratio of the composite compound phase based on 100 area % in total of the binder phase is indicated by the content ratio X1, and the content ratio of the composite compound phase based on 100 area % in total of the binder phase in a range from the interface between the cBN and the binder phase to a distance of 300 nm toward the binder phase is indicated by a content ratio X2, the content ratio X2 is larger than the content ratio X1, whereby when, among the Ti compound phases, the composite compound phase having excellent toughness but poor thermal conductivity is unevenly distributed in the vicinities of the surfaces of cBN particles having excellent thermal conductivity, the toughness improves without degrading the thermal shock resistance of the cBN sintered body, and the cBN sintered body of the present embodiment is thus mainly excellent in fracture resistance.

The cBN sintered body of the present embodiment contains the cBN and the binder phase. The content ratio of the cBN is 10.0 area % or more and 60.0 area % or less, and the content ratio of the binder phase is 40.0 area % or more and 90.0 area % or less. In the cBN sintered body according to the present embodiment, the total content ratio of the cBN and the binder phase becomes 100.0 area %.

In the cBN sintered body of the present embodiment, the content ratios (area %) of the cBN and the binder phase, and the Ti compound phase, the Al compound phase, and the composite compound phase in the binder phase can be obtained by capturing an arbitrary cross section with a scanning electron microscope (SEM) and combining analysis of the captured SEM photograph with commercially available image analysis software and analysis with an energy-dispersive X-ray analyzer (EDS). Specifically, the content ratios can be obtained by a method to be described in Examples below.

[Cubic Boron Nitride (cBN)]

When the cross-sectional structure of the cBN sintered body is observed, the content ratio of the cBN is 10.0 area % or more based on 100 area % in total of the cBN sintered body, whereby the content ratio of the cBN having excellent mechanical strength becomes high, and the cBN sintered body is thus mainly excellent in fracture resistance. On the other hand, the content ratio of the cBN is 60.0 area % or less, whereby the content ratio of the cBN, which is poor in reaction resistance with iron, is low, and the cBN sintered body of the present embodiment is thus mainly excellent in wear resistance. From the same viewpoint, the content ratio of the cBN is preferably 15.0 area % or more and 55.0 area % or less, more preferably 20.0 area % or more and 50.0 area % or less, and still more preferably 25.0 area % or more and 40.0 area % or less.

### [Binder Phase]

When the cross-sectional structure of the cBN sintered body is observed, the content ratio of the binder phase is 40.0 area % or more based on 100 area % in total of the cBN sintered body, whereby the content ratio of cBN, which is poor in reaction resistance with iron, becomes relatively low, and the cBN sintered body of the present embodiment is thus mainly excellent in wear resistance. On the other hand, the content ratio of the binder phase is 90.0 area % or less, whereby the content ratio of cBN having excellent mechanical strength becomes relatively high, and the cBN sintered body of the present embodiment is thus mainly excellent in fracture resistance. From the same viewpoint, the content ratio of the binder phase is preferably 45.0 area % or more and 85.0 area % or less, more preferably 50.0 area % or more and 80.0 area % or less, and still more preferably 60.0 area % or more and 75.0 area % or less.

### [Al Compound Phase]

In the cBN sintered body of the present embodiment, the binder phase includes the Al compound phase.

The content ratio of the Al compound phase is more than 0.0 area % and 20.0 area % or less based on 100 area % in total of the binder phase. When the content ratio of the Al compound phase is more than 0.0 area %, the sinterability of the cBN sintered body improves, and the cBN sintered body is thus mainly excellent in fracture resistance. On the other hand, the content ratio of the Al compound phase is 20.0 area % or less, whereby the formation of a coarse Al compound is curbed, and the chipping resistance improves, and the cBN sintered body is thus mainly excellent in fracture resistance. From the same viewpoint, the content ratio of the Al compound phase is preferably 2.1 area % or more and 17.9 area % or less, more preferably 3.0 area % or more and 15.0 area % or less, and still more preferably 5.0 area % or more and 12.1 area % or less based on 100 area % in total of the binder phase.

In the cBN sintered body of the present embodiment, the Al compound phase contains a compound of Al and at least one element selected from the group consisting of C, N, O, and B. When the Al compound phase contains such a compound, the sinterability of the cBN sintered body improves, and the cBN sintered body thus tends to be excellent in fracture resistance. From the same viewpoint, the Al compound phase preferably contains at least one selected from the group consisting of Al₂O₃, AlN, and AlB₂, more preferably contains at least one selected from the group consisting of Al₂O₃ and AlN, and still more preferably contains Al₂O₃.

### [Ti Compound Phase]

In the cBN sintered body of the present embodiment, the binder phase includes the Ti compound phase.

The content ratio of the Ti compound phase is 80.0 area % or more based on 100 area % in total of the binder phase, whereby the reaction resistance with iron improves, and the cBN sintered body is thus mainly excellent in wear resistance. On the other hand, the content ratio of the Ti compound phase is less than 100.0 area %, whereby the toughness improves, and the cBN sintered body is thus mainly excellent fracture resistance. From the same viewpoint, the content ratio of the Ti compound phase is preferably 82.1 area % or more and 97.9 area % or less, more preferably 85.0 area % or more and 97.0 area % or less, and still more preferably 87.9 area % or more and 95.0 area % or less.

The Ti compound phase contains at least one selected from the group consisting of a compound of Ti and at least one element selected from the group consisting of C, N, O, and B and a compound of Ti, at least one element selected from the group consisting of V, Cr, Zr, Nb, Mo, Hf, Ta, and W, and at least one element selected from the group consisting of C, N, O, and B. When the Ti compound phase contains such a compound, the reaction resistance with iron improves, and the cBN sintered body is thus mainly excellent in wear resistance. From the same viewpoint, aside from a composite compound phase to be described below, the Ti compound phase preferably contains at least one selected from the group consisting of TiC, TiCN, TiN, and TiB₂, more preferably contains at least one selected from the group consisting of TiC, TiCN, and TiB₂, still more preferably contains at least one selected from the group consisting of TiC and TiB₂, and particularly preferably contains TiC and TiB₂.

### [Composite Compound Phase]

In the cBN sintered body of the present embodiment, the Ti compound phase includes the composite compound phase.

The content ratio X1 of the composite compound phase based on 100 area % in total of the binder phase is preferably 2.0 area % or more and 30.0 area % or less. The content ratio X1 is 2.0 area % or more, whereby the toughness improves, and the cBN sintered body thus tends to be mainly excellent in fracture resistance. On the other hand, the content ratio X1 of the composite compound phase is 30.0 area % or less, and the Ti compound phase thus contains a relatively large amount of the Ti compound phase other than the composite compound phase, whereby the thermal conductivity of the binder phase improves, and the thermal shock resistance improves, and the cBN sintered body thus tends to be excellent in fracture resistance. In addition, since the thermal conductivity improves, the wear resistance also tends to improve. From the same viewpoint, the content ratio X1 of the composite compound phase is more preferably 2.5 area % or more and 18.9 area % or less, still more preferably 3.8 area % or more and 15.0 area % or less, and particularly preferably 6.3 area % or more and 10.7 area % or less.

In the cBN sintered body of the present embodiment, the content ratio X2 of the composite compound phase based on 100 area % in total of the binder phase in a range from the interface between cBN and the binder phase to a distance of 300 nm toward the binder phase is preferably 3.0 area % or more and 45.0 area % or less. The content ratio X2 is 3.0 area % or more, whereby the propagation of cracks generated during cutting to cBN is curbed, and the cBN sintered body thus tends to be excellent in fracture resistance. On the other hand, the content ratio X2 is 45.0 area % or less, whereby the sinterability improves, and the cBN sintered body thus tends to be excellent in fracture resistance. From the same viewpoint, the content ratio X2 is more preferably 4.5 area % or more and 41.4 area % or less, still more preferably 6.2 area % or more and 27.4 area % or less, and particularly preferably 9.7 area % or more and 20.5 area % or less.

“The total of the binder phase” in the definition of the content ratio X2 means the whole of the binder phase in a range from the interface between the cBN and the binder phase to a distance of 300 nm toward the binder phase, and “the content ratio X2 of the composite compound phase” means the content ratio of the composite compound phase in a range from the interface between the cBN and the binder phase to a distance of 300 nm toward the binder phase. In addition, in a case where the region of the binder phase is narrow and there is a portion where the range from the interface between the cBN and the binder phase to a distance of 300 nm toward the binder phase and a range from another interface between the cBN and the binder phase to a distance of 300 nm toward the binder phase overlap double, the area of the overlapping portion is not counted twice. In a case where there is a portion where the ranges overlap triple or more as well, similarly, the area of the overlapping portion is not counted three or more times.

The ratio (X2/X1) of the content ratio X2 to the content ratio X1 is preferably 1.10 or more and 2.10 or less. When the ratio (X2/X1) of the content ratio X2 to the content ratio X1 is 1.10 or more, the effect of, among the Ti compound phases, the composite compound phase having excellent toughness but poor thermal conductivity being unevenly distributed in the vicinities of the surfaces of the cBN particles having excellent thermal conductivity is more effectively and reliably exhibited, and the toughness improves without degrading the thermal shock resistance of the cBN sintered body, and the cBN sintered body tends to be excellent in fracture resistance. On the other hand, when the ratio (X2/X1) of the content ratio X2 to the content ratio X1 is 2.10 or less, in the binder phase, the frequency of the binder phase other than the composite compound phase being in contact with the composite compound phase increases, the toughness of the binder phase improves, and the fracture resistance thus also tends to improve. In addition, the thermal conductivity improves, and the wear resistance also thus tends to improve. From the same viewpoint, the ratio (X2/X1) of the content ratio X2 to the content ratio X1 is more preferably 1.16 or more and 2.05 or less, still more preferably 1.31 or more and 1.97 or less, and particularly preferably 1.37 or more and 1.81 or less.

In the cBN sintered body of the present embodiment, the composite compound phase contains at least one selected from the group consisting of a carbide, a nitride, and a carbonitride each containing Ti and at least one element selected from the group consisting of V, Cr, Zr, Nb, Mo, Hf, Ta, and W (hereinafter also referred to as the element M). When the composite compound phase contains such a compound, the toughness improves, and the cBN sintered body is thus mainly excellent in fracture resistance. From the same viewpoint, the composite compound phase more preferably contains at least one selected from the group consisting of a carbide, a nitride, and a carbonitride each containing Ti and the element M, still more preferably contains at least one selected from the group consisting of a carbide and a nitride each containing Ti and the element M, and particularly preferably contains a carbide containing Ti and the element M. In addition, the element M is preferably at least one element selected from the group consisting of V, Zr, Nb, Mo, Ta, and W, more preferably at least one element selected from the group consisting of Zr, Nb, Mo, Ta, and W, and still more preferably W.

In the cBN sintered body of the present embodiment, the average grain size of the composite compound phase is preferably 0.8 μm or more and 3.0 μm or less. When the average grain size of the composite compound phase is 0.8 μm or more, the toughness improvement effect of the composite compound phase being contained tends to be more effectively and reliably exhibited. On the other hand, when the average grain size of the composite compound phase is 3.0 μm or less, the effect of the content ratio X2 being made to be larger than the content ratio X1 tends to be more effectively and reliably exhibited. From the same viewpoint, the average grain size of the composite compound phase is preferably 1.0 μm or more and 2.8 μm or less, more preferably 1.2 μm or more and 2.4 μm or less, and particularly preferably 1.4 μm or more and 2.0 μm or less. The average grain size of the composite compound phase is measured by a method to be described in Examples.

In the cBN sintered body of the present embodiment, the ratio of content ratio of the element M to the total content ratio of Ti and the element M (atomic ratio M/(Ti+M)) is preferably 0.10 or more and 0.60 or less in the composite compound phase. When the atomic ratio M/(Ti+M) in the composite compound phase is 0.10 or more, the toughness improvement effect of the composite compound phase being contained tends to be more effectively and reliably exhibited. On the other hand, when the atomic ratio M/(Ti+M) in the composite compound phase is 0.60 or less, the sinterability improves, and the cBN sintered body thus tends to be excellent in fracture resistance. From the same viewpoint, the atomic ratio M/(Ti+M) is more preferably 0.11 or more and 0.57 or less, still more preferably 0.17 or more and 0.55 or less, and particularly preferably 0.30 or more and 0.48 or less.

### [Other Phases]

The binder phase of the cBN sintered body of the present embodiment may include, in addition to the Al compound phase and the Ti compound phase, at least one selected from the third group consisting of a metal of at least one element selected from the first group consisting of Ti, V, Cr, Zr, Nb, Mo, Hf, Ta, W, Al, Si, Co, and Ni, an alloy composed of at least two elements selected from the first group, and a compound of at least one selected from the first group and at least one compound selected from the second group consisting of C, N, O, and B elements. The binder phase further contains such a component, whereby the sinterability improves, and the cBN sintered body thus tends to be excellent in fracture resistance. Examples of such a component include V, VC, VN, Cr, Cr₃C₂, CrN, Cr₂N, Hf, HfC, HfN, Ta, TaC, TaN, Si, SiC, Si₃N₄, W, WC, Mo, Mo₂C, Nb, NbC, NbN, Zr, ZrC, ZrN, ZrO₂, Co, CoAl, and Ni. Among these, from the same viewpoint as described above, the binder phase more preferably contains VC, TaC, WC, Mo₂C, NbC, ZrN, CrN, Ni, or Co, and still more preferably contains Ni or CO. In addition, in a case where the binder phase contains such a compound, the content ratio thereof is preferably 0.1 area % or more and 10.0 area % or less, and more preferably 0.5 area % or more and 9.0 area % or less based on 100 area % in total of the binder phase.

In the present embodiment, the compositions of the cBN and each compound in the binder phase can be identified using a commercially available X-ray diffraction measuring instrument. For example, when X-ray diffraction measurement of a 2 θ/θ focusing optical system using Cu-Kα rays is performed under predetermined conditions using Rigaku's X-ray diffractometer (product name “SmartLab”), the compositions of the cBN and the binder phase can be identified. As the measurement conditions, it is preferable to set the conditions to, for example, output: 45 kV, 200 mA, incident side solar slit: 5°, divergence longitudinal slit: 2/3°, divergence longitudinal limit slit: 5 mm, scattering slit 2/3°, receiving side solar slit: 5°, receiving slit: 0.3 mm, Sampling width: 0.02°, scanning speed: 1°/min, and 2 θ measurement range: 30° to 90°.

In addition, in a case where identification by the X-ray diffraction measurement is difficult, the composition of each compound can also be identified by a method to be described in Examples below (analysis with a SEM image and EDS analysis).

In the present embodiment, the cBN sintered body may inevitably contain an impurity. Examples of the inevitable impurity are not particularly limited, and examples thereof include lithium, calcium, silicon and magnesium that are contained in a raw material powder. The content ratio of the inevitable impurity is usually 1 mass % or less based on the whole of the cBN sintered body. Therefore, the inevitable impurity rarely affects the characteristic values of the cBN sintered body.

### [Method for Producing Cubic Boron Nitride Sintered Body]

### (Preparation and Weighing Process of Raw Material Powders)

The cBN sintered body of the present embodiment can be produced by, for example, the following method.

As raw material powders, a cubic boron nitride (cBN) powder, Al powder, TiC powder, TiCN powder, TiN powder, TiC_{0.8} powder, TiCN_{0.8} powder, TiN_{0.8} powder, Ni powder, Co powder, TiWC powders (Ti_{0.6}W_{0.4}C, Ti_{0.8}W_{0.2}C), WC powder, TiWTaC powder (Ti_{0.6}W_{0.3}Ta_{0.1}C), VC powder, VN powder, Cr₃C₂ powder, Cr₂N powder, Mo₂C powder, NbC powder, NbN powder, HfC powder, HfN powder, ZrC powder, ZrN powder, WC powder and the like are prepared. Here, the average grain size of the composite compound phase to be obtained can also be adjusted by adjusting the average particle sizes of the raw material powders containing the element M. In addition, the content ratios (area %) of the cBN and the binder phase in the cBN sintered body to be obtained can be controlled to be within the above-described specific range by appropriately adjusting the ratio of each of the raw material powders. In addition, the atomic ratio M/(Ti+M) in the composite compound phase can be controlled to be within the above-described specific range by appropriately adjusting the ratios of the raw material powders containing the element M.

### (Modification Process and Stirring Process)

Here, the surfaces of these powders are modified with an anionic polymer for the cBN powder and with a cationic polymer for the raw material powders containing the element M (modification process). Each of the surface-modified cBN powder and the surface-modified raw material powders containing the element M is stirred in ethanol for one to 24 hours, whereby the powders are electrostatically adsorbed to each other, and furthermore, centrifugation is performed to remove an excess polymer (stirring process).

Such modification process and stirring process make the content ratio X2 tend to become larger than the content ratio X1. In addition, the modification process and the stirring process, and the prolonging of the treatment time in the stirring process make the ratio (X2/X1) of the content ratio X2 to the content ratio X1 tend to become large. Furthermore, when the average particle sizes of the raw material powders containing the element M are reduced, and the modification process and the stirring process are then performed, the ratio (X2/X1) of the content ratio X2 to the content ratio X1 tends to become large. In a case where the ratio (X2/X1) becomes large by these methods, the content ratio X2 also tends to become large.

### (Mixing Process)

Next, each of the prepared raw material powders is put into a cylinder for ball milling together with alumina balls, hexane solvent, and paraffin and mixed. The content ratio (area %) of the Ti compound phase and the content ratio (area %) of the Al compound phase in the binder phase and the content ratio X1 (area %) of the composite compound phase in the Ti compound phase can be controlled to be within the above-described specific ranges by appropriately adjusting the ratio of each of the raw material powders.

The composite compound phase can be obtained using carbide, nitride, and carbonitride raw material each containing Ti and the element M described above or using carbide, nitride, and carbonitride raw material of the element M and TiC_{0.8}, TiCN_{0.8}, and/or TiN_{0.8} raw materials. In addition, when a raw material powder containing the element M in which the atomic ratio of the element M to the total of Ti and the element M is small is used, the atomic ratio M/(Ti+M) in the composite compound phase tends to become small. Furthermore, when TiC_{0.8} powder, TiCN_{0.8} powder, and/or TiN_{0.8} powder are used as raw materials other than the composite compound phase, and the ratios thereof are set to be large, the atomic ratio M/(Ti+M) in the composite compound phase tends to become small.

### (Loading Process, Drying Process, and Sintering Process)

The raw material powders mixed by ball milling are loaded into a high-melting point metal capsule made of Zr under a nitrogen atmosphere in a glove box (loading process). In order to remove moisture and an organic component adsorbed to the surfaces of the loaded raw material powders, a vacuum heat treatment is performed with the capsule open (drying process). After the vacuum heat treatment, the capsule is sealed, and the raw material powders loaded into the capsule are sintered at a high temperature and a high pressure (sintering process). The sintering conditions are, for example, pressure: 4.0 GPa to 7.0 GPa, temperature: 1200° C. to 1500° C., and sintering time: 20 minutes to 60 minutes.

As a more specific production method, a method to be described in Examples below may also be used.

### [Coated Cubic Boron Nitride Sintered Body]

A coated cubic boron nitride sintered body of the present embodiment includes the above-described cBN sintered body and a coating layer formed on the surface of the cBN sintered body, the coating layer is a single layer or a lamination of two or more layers containing at least one element selected from the group consisting of Ti, Zr, Hf, V, Nb, Ta, Cr, Mo, W, Al, and Si and at least one element selected from the group consisting of C, N, O, and B, and an average thickness of a whole of the coating layer is 0.5 μm or more and 8.0 μm or less.

The wear resistance of the cBN sintered body further improves due to the coating layer formed on the surface of the cBN sintered body. In addition, the coated cBN sintered body of the present embodiment, in which the coating layer contains the above-described components and has the above-described configuration, has excellent wear resistance. Furthermore, the average thickness of the whole of coating layer is 0.5 μm or more, whereby the wear resistance mainly improves, and the average thickness is 8.0 μm or less, whereby the occurrence of fracture attributed to peeling is curbed, and the coated cBN sintered body is mainly excellent in fracture resistance. From such a viewpoint, the average thickness of the whole of coating layer is preferably 1.0 μm or more and 6.5 μm or less and more preferably 1.5 μm or more and 6.0 μm or less.

Examples of a compound that forms the coating layer include TiCN, TiC, TiN, TiAlN, TiSiN, CrN, and NbN. The coating layer may have a structure in which a plurality of layers having different compositions are alternately laminated. In this case, the average thickness per layer in each layer is, for example, 5 nm or more and 500 nm or less.

The thickness of each layer configuring the coating layer and the thickness of the whole of coating layer can be measured from the cross-sectional structure of the coated cBN sintered body using an optical microscope, SEM, transmission electron microscope (TEM), or the like. The average thickness of each layer and the average thickness of the whole of coating layer in the coated cubic boron nitride sintered body can be obtained by measuring the thicknesses of each layer and the thicknesses of the whole of coating layer from the cross sections of three or more places in the vicinity of a position 50 μm apart from the cutting edge of a surface facing a metal evaporation source toward the central portion of the surface and calculating the average value thereof.

In addition, the composition of each layer configuring the coating layer can be measured from the cross-sectional structure of the coated cBN sintered body with EDS, a wavelength dispersive X-ray analyzer (WDS), or the like.

A method for producing the coating layer in the coated cBN sintered body of the present embodiment is not particularly limited, examples thereof include chemical vapor deposition methods and physical vapor deposition methods such as an ion plating method, an arc ion plating method, a sputtering method, and an ion mixing method. Among them, the arc ion plating method is preferable since the adhesion between the coating layer and the cBN sintered body is superior.

### [Tool]

A tool of the present embodiment includes the above-described cBN sintered body or the above-described coated cBN sintered body. The tool of the present embodiment includes the cBN sintered body or the coated cBN sintered body and may further have the same configuration as known tools. Since the cBN sintered body or coated cBN sintered body of the present embodiment is excellent in wear resistance and fracture resistance, the tool including them can be used as, for example, a cutting tool and a wear-resistance tool, and between them, the tool is preferably used as a cutting tool. The cBN sintered body or coated cBN sintered body of the present embodiment is more preferably included in cutting tools for carburized and quenched steel. In a case where the cBN sintered body or coated cBN sintered body of the present embodiment is included in a cutting tool or a wear-resistant tool, the tool life can be extended more than ever.

### EXAMPLES

Hereinafter, the present invention will be described more specifically using Examples. The present invention is in no way limited by the following Examples.

### Example 1

### [Preparation and Weighing Process of Raw Material Powders]

As raw material powders, cubic boron nitride (cBN) powder, Al powder, TiC powder, TiCN powder, TiN powder, TiC_{0.8} powder, TiN_{0.8} powder, Ni powder, Co powder, and a raw material powder containing an element M were prepared, and weighed in the ratios shown in Table 1 and Table 2 below. The type of the raw material powder containing the element M was as shown in Table 1. The average particle sizes thereof were 2.0 μm (cBN powder), 1.8 μm (Al powder), 1.0 μm (TiC powder), 1.0 μm (TiCN powder), 1.0 μm (TiN powder), 1.0 μm (TiC_{0.8} powder), 1.0 μm (TiN_{0.8} powder), 1.5 μm (Ni powder), and 1.5 μm (Co powder), respectively, and the average particle size of the raw material powder containing the element M was as shown in Table 1 and Table 2. The average particle sizes of the raw material powders were measured by the Fisher method (Fisher Sub-Sieve Sizer (FSSS)) described in the American Society for Testing Materials (ASTM) Standard B330.

TABLE 1

| | Blending Composition (Volume %) | | | | | | | | | | | |
|---|---|---|---|---|---|---|---|---|---|---|---|---|
| | | | | | | | | | | Raw Material Powder Containing Element M | | |
| | | | | | | | | | | | | Average |
| | | | | | | | | | | | | Particle |
| Sample No. | cBN | Al | TiC | TiCN | TiN | TiC_{0.8} | TiN0.8 | Ni | Co | Type | (Volume %) | Size(μm) |
| Invention | 30.0 | 5.0 | 58.0 | — | — | — | — | — | — | Ti_{0.6}W_{0.4}C | 7.0 | 1.6 |
| Sample 1 | | | | | | | | | | | | |
| Invention | 15.0 | 6.5 | 70.0 | — | — | — | — | — | — | Ti_{0.6}W_{0.4}C | 8.5 | 1.6 |
| Sample 2 | | | | | | | | | | | | |
| Invention | 25.0 | 5.5 | 62.0 | — | — | — | — | — | — | Ti_{0.6}W_{0.4}C | 7.5 | 1.6 |
| Sample 3 | | | | | | | | | | | | |
| Invention | 50.0 | 4.0 | 41.0 | — | — | — | — | — | — | Ti_{0.6}W_{0.4}C | 5.0 | 1.6 |
| Sample 4 | | | | | | | | | | | | |
| Invention | 60.0 | 3.0 | 33.0 | — | — | — | — | — | — | Ti_{0.6}W_{0.4}C | 4.0 | 1.6 |
| Sample 5 | | | | | | | | | | | | |
| Invention | 30.0 | 1.5 | 62.0 | — | — | — | — | — | — | Ti_{0.6}W_{0.4}C | 6.5 | 1.6 |
| Sample 6 | | | | | | | | | | | | |
| Invention | 30.0 | 3.5 | 60.0 | — | — | — | — | — | — | Ti_{0.6}W_{0.4}C | 6.5 | 1.6 |
| Sample 7 | | | | | | | | | | | | |
| Invention | 30.0 | 8.5 | 55.0 | — | — | — | — | — | — | Ti_{0.6}W_{0.4}C | 6.5 | 1.6 |
| Sample 8 | | | | | | | | | | | | |
| Invention | 30.0 | 12.5 | 50.0 | — | — | — | — | — | — | Ti_{0.6}W_{0.4}C | 7.5 | 1.6 |
| Sample 9 | | | | | | | | | | | | |
| Invention | 30.0 | 5.0 | 58.0 | — | — | — | — | — | — | Ti_{0.6}W_{0.4}C | 7.0 | 2.8 |
| Sample 10 | | | | | | | | | | | | |
| Invention | 30.0 | 5.0 | 58.0 | — | — | — | — | — | — | Ti_{0.6}W_{0.4}C | 7.0 | 2.4 |
| Sample 11 | | | | | | | | | | | | |
| Invention | 30.0 | 5.0 | 58.0 | — | — | — | — | — | — | Ti_{0.6}W_{0.4}C | 7.0 | 0.8 |
| Sample 12 | | | | | | | | | | | | |
| Invention | 30.0 | 5.0 | 58.0 | — | — | — | — | — | — | Ti_{0.6}W_{0.4}C | 7.0 | 0.6 |
| Sample 13 | | | | | | | | | | | | |
| Invention | 20.0 | 6.0 | 72.0 | — | — | — | — | — | — | Ti_{0.6}W_{0.4}C | 2.0 | 1.0 |
| Sample 14 | | | | | | | | | | | | |
| Invention | 20.0 | 6.0 | 71.0 | — | — | — | — | — | — | Ti_{0.6}W_{0.4}C | 3.0 | 1.0 |
| Sample 15 | | | | | | | | | | | | |
| Invention | 20.0 | 6.0 | 69.0 | — | — | — | — | — | — | Ti_{0.6}W_{0.4}C | 5.0 | 1.6 |
| Sample 16 | | | | | | | | | | | | |
| Invention | 55.0 | 3.5 | 33.0 | — | — | — | — | — | — | Ti_{0.6}W_{0.4}C | 8.5 | 2.0 |
| Sample 17 | | | | | | | | | | | | |
| Invention | 55.0 | 3.5 | 28.0 | — | — | — | — | — | — | Ti_{0.6}W_{0.4}C | 13.5 | 2.0 |
| Sample 18 | | | | | | | | | | | | |
| Invention | 30.0 | 5.0 | — | — | — | 58.0 | — | — | — | Ti_{0.6}W_{0.4}C | 7.0 | 0.8 |
| Sample 19 | | | | | | | | | | | | |
| Invention | 30.0 | 5.0 | 58.0 | — | — | — | — | — | — | Ti_{0.6}W_{0.4}C | 7.0 | 1.0 |
| Sample 20 | | | | | | | | | | | | |
| Invention | 30.0 | 5.0 | 15.0 | — | — | 43.0 | — | — | — | WC/Ti_{0.6}W_{0.4}C | 3.5/3.5 | 1.0 |
| Sample 21 | | | | | | | | | | | | |
| Invention | 30.0 | 5.0 | — | — | — | 58.0 | — | — | — | WC | 7.0 | 1.0 |
| Sample 22 | | | | | | | | | | | | |
| Invention | 30.0 | 5.0 | 58.0 | — | — | — | — | — | — | Ti_{0.6}W_{0.3}Ta_{0.1}C | 7.0 | 1.6 |
| Sample 23 | | | | | | | | | | | | |
| Invention | 30.0 | 5.0 | — | — | — | 58.0 | — | — | — | Mo₂C | 7.0 | 1.0 |
| Sample 24 | | | | | | | | | | | | |
| Invention | 30.0 | 5.0 | — | — | — | 58.0 | — | — | — | NbC | 7.0 | 1.0 |
| Sample 25 | | | | | | | | | | | | |
| Invention | 30.0 | 5.0 | — | — | — | — | 58.0 | — | — | ZrN | 7.0 | 1.0 |
| Sample 26 | | | | | | | | | | | | |
| Invention | 30.0 | 5.0 | — | 58.0 | — | — | — | — | — | Ti_{0.6}W_{0.4}C | 7.0 | 1.6 |
| Sample 27 | | | | | | | | | | | | |
| Invention | 30.0 | 5.0 | — | — | 58.0 | — | — | — | — | Ti_{0.6}W_{0.4}C | 7.0 | 1.6 |
| Sample 28 | | | | | | | | | | | | |
| Invention | 30.0 | 5.0 | — | — | — | 54.0 | — | 4.0 | — | Ti_{0.6}W_{0.4}C | 7.0 | 1.6 |
| Sample 29 | | | | | | | | | | | | |
| Invention | 30.0 | 5.0 | — | — | — | 54.0 | — | — | 4.0 | Ti_{0.6}W_{0.4}C | 7.0 | 1.6 |
| Sample 30 | | | | | | | | | | | | |

TABLE 2

| | Blending Composition (Volume %) | | | | | | | | | | | |
|---|---|---|---|---|---|---|---|---|---|---|---|---|
| | | | | | | | | | | Raw Material Powder Containing Element M | | |
| | | | | | | | | | | | | Average |
| | | | | | | | | | | | | Particle |
| Sample No. | cBN | Al | TiC | TiCN | TiN | TiC_{0.8} | TiN_{0.8} | Ni | Co | Type | (Volume %) | Size(μm) |
| Comparative | 5.0 | 7.0 | 78.0 | — | — | — | — | — | — | Ti_{0.6}W_{0.4}C | 10.0 | 1.6 |
| Sample 1 | | | | | | | | | | | | |
| Comparative | 5.0 | 7.0 | 78.0 | — | — | — | — | — | — | Ti_{0.6}W_{0.4}C | 10.0 | 0.6 |
| Sample 2 | | | | | | | | | | | | |
| Comparative | 5.0 | 7.0 | 78.0 | — | — | — | — | — | — | Ti_{0.6}W_{0.4}C | 10.0 | 0.8 |
| Sample 3 | | | | | | | | | | | | |
| Comparative | 70.0 | 2.0 | 25.0 | — | — | — | — | — | — | Ti_{0.6}W_{0.4}C | 3.0 | 1.6 |
| Sample 4 | | | | | | | | | | | | |
| Comparative | 70.0 | 2.0 | 15.5 | — | — | — | — | — | — | Ti_{0.6}W_{0.4}C | 12.5 | 2.0 |
| Sample 5 | | | | | | | | | | | | |
| Comparative | 30.0 | 0.0 | 63.0 | — | — | — | — | — | — | Ti_{0.6}W_{0.4}C | 7.0 | 1.6 |
| Sample 6 | | | | | | | | | | | | |
| Comparative | 30.0 | 17.5 | 46.0 | — | — | — | — | — | — | Ti_{0.6}W_{0.4}C | 6.5 | 1.6 |
| Sample 7 | | | | | | | | | | | | |
| Comparative | 30.0 | 5.0 | 58.0 | — | — | — | — | — | — | Ti_{0.6}W_{0.4}C | 7.0 | 1.6 |
| Sample 8 | | | | | | | | | | | | |
| Comparative | 30.0 | 5.0 | 58.0 | — | — | — | — | — | — | Ti_{0.6}W_{0.4}C | 7.0 | 3.2 |
| Sample 9 | | | | | | | | | | | | |
| Comparative | 20.0 | 6.0 | 74.0 | — | — | — | — | — | — | — | — | — |
| Sample 10 | | | | | | | | | | | | |

### [Modification Process]

The surfaces of the raw material powders were modified using sodium polystyrene sulfonate, which is an anionic polymer, for, among the weighed raw material powders, the cBN powder and polydiallyldimethylammonium chloride, which is a cationic polymer, for the raw material powder containing the element M, respectively.

### [Stirring Process]

Next, the surface modified cBN powder and the surface modified raw material powder containing the element M were stirred in ethanol to electrostatically adsorb the powders together. The stirring time was set to a time shown in Table 3. After stirring, centrifugation was performed to remove an excess polymer. For Comparative Sample 8 and Comparative Sample 10, the modification process and the stirring process were omitted.

TABLE 3

| | Modification | |
|---|---|---|
| | Process | Stirring |
| | Presence or | Process |
| | absence of | Treatment |
| Sample No. | Process | Time (hr) |
| Invention Sample 1 | Present | 12 |
| Invention Sample 2 | Present | 12 |
| Invention Sample 3 | Present | 12 |
| Invention Sample 4 | Present | 12 |
| Invention Sample 5 | Present | 12 |
| Invention Sample 6 | Present | 12 |
| Invention Sample 7 | Present | 12 |
| Invention Sample 8 | Present | 12 |
| Invention Sample 9 | Present | 12 |
| Invention Sample 10 | Present | 6 |
| Invention Sample 11 | Present | 12 |
| Invention Sample 12 | Present | 18 |
| Invention Sample 13 | Present | 18 |
| Invention Sample 14 | Present | 18 |
| Invention Sample 15 | Present | 12 |
| Invention Sample 16 | Present | 12 |
| Invention Sample 17 | Present | 12 |
| Invention Sample 18 | Present | 12 |
| Invention Sample 19 | Present | 12 |
| Invention Sample 20 | Present | 12 |
| Invention Sample 21 | Present | 12 |
| Invention Sample 22 | Present | 12 |
| Invention Sample 23 | Present | 12 |
| Invention Sample 24 | Present | 12 |
| Invention Sample 25 | Present | 12 |
| Invention Sample 26 | Present | 12 |
| Invention Sample 27 | Present | 12 |
| Invention Sample 28 | Present | 12 |
| Invention Sample 29 | Present | 12 |
| Invention Sample 30 | Present | 12 |
| Comparative Sample 1 | Present | 12 |
| Comparative Sample 2 | Present | 18 |
| Comparative Sample 3 | Present | 18 |
| Comparative Sample 4 | Present | 12 |
| Comparative Sample 5 | Present | 12 |
| Comparative Sample 6 | Present | 12 |
| Comparative Sample 7 | Present | 12 |
| Comparative Sample 8 | Absent | — |
| Comparative Sample 9 | Present | 0.5 |
| Comparative Sample 10 | Absent | — |

### [Mixing Process]

The raw material powders after the stirring process and the remaining raw material powders after the weighing were put into a cylinder for ball milling together with alumina balls, hexane solvent, and paraffin and mixed for six hours. For Comparative Sample 8 and Comparative Sample 10, the modification process and the stirring process were omitted, and the weighed raw material powders were mixed as described above.

### [Loading Process and Drying Process]

The mixed raw material powders were loaded into a high-melting point metal capsule made of Zr (hereinafter simply referred to as “capsule”) under a nitrogen atmosphere in a glove box. In order to remove moisture and an organic component adsorbed to the surfaces of the loaded raw material powders, a vacuum heat treatment was performed with the capsule open. After the vacuum heat treatment, the capsule was sealed.

### [Sintering Process]

Next, the raw material powders loaded into the capsule were sintered at a high temperature and a high pressure for 60 minutes. The sintering conditions will be shown below.
Sintering temperature: 1250° C.,
Pressure: 6.0 GPa.

### [Composition Analysis by X-ray Diffraction (XRD)]

Regarding the cBN and the binder phases contained in the cBN sintered body obtained by the sintering process, composition analysis was performed by X-ray diffraction (XRD). The compositions of the cBN and the binder phase were identified using an X-ray diffractometer (product name “SmartLab”) manufactured by Rigaku Corporation. Specifically, X-ray diffraction measurement of a 2 θ/θ focusing optical system using Cu-Kα rays was measured under the following conditions to identify the compositions of the cBN and the binder phase.

### <X-ray Diffraction Measurement Conditions>

Output: 45 kV, 200 mA,
Incident side solar slit: 5°;
Divergence longitudinal slit: 2/3°,
Divergence longitudinal limit slit: 5 mm,
Scattering slit 2/3°,
Receiving side solar slit: 5°;
Receiving slit: 0.3 mm,
Sampling width: 0.02°;
Scanning speed: 1°/min,
2 θ measurement range: 30° to 90°.

The analysis results are shown in Tables 4 to 6. In Tables 4 to 6, only phases from which a clear peak was obtained by X-ray diffraction measurement were specified and indicated. Carbides, nitrides, and carbonitrides each containing Ti, which were difficult to identify by X-ray diffraction measurements, and carbides, nitrides, and carbonitrides each containing Ti and the element M were specified by combining analysis using EDS, which will be described below.

### [Analysis of SEM Images and Analysis by EDS]

The content ratios (area %) of the cBN and the binder phase in the cBN sintered body obtained by the sintering were obtained by analyzing the cross-sectional structure photograph of the cBN sintered body captured with a scanning electron microscope (SEM) with commercially available image analysis software. More specifically, the cBN sintered body was polished in a direction perpendicular to the surface thereof to obtain a mirror-polished surface. Next, the mirror-polished surface of the cBN sintered body enlarged at a magnification of 5000 times was observed with a reflection electron image using the SEM. Black regions were specified as cBN, and gray regions and white regions were specified as the binder phase using an energy-dispersive X-ray analyzer (EDS) attached to the SEM. Furthermore, in the binder phase, dark gray regions were specified as an Al compound phase, and light gray and white regions were specified as a Ti compound phase. After that, tissue photographs of the cross section of the cBN were captured using the SEM. The tissue photographs were captured to include a 15 μm×15 μm field of view, and the tissue photographs of a total of 20 fields of view were obtained. The occupied areas of the cBN and the binder phase were each obtained from the tissue photographs using image analysis software, and the content ratios (area %) were obtained from the occupied areas. In addition, the content ratio (area %) of the Ti compound phase and the content ratio (area %) of the Al compound phase in the binder phase were also calculated from the occupied areas of the respective phases with respect to the occupied area of the binder phase in the same manner from the tissue photographs. The average value of the content ratios obtained from the tissue photographs of a total of the 20 fields of view was regarded as the content ratios of each sample. In addition, for Invention Samples 29 and 30 in which the binder phase contained a material other than the Al compound phase and the Ti compound phase, the phases were specified in combination with mapping analysis by EDS, which will be described below, and the occupied areas of phases other than the Al compound phase and the Ti compound phase in the respective invention samples were obtained, and the content ratios (area %) were calculated.

The content ratios (area %) of the composite compound phase and the Ti compound phase other than the composite compound phase in the binder phase were calculated by combining the image analysis of a tissue photograph of the cBN sintered body captured with the SEM in the same manner as described above and mapping analysis by EDS. Specifically, mapping analysis of the same fields of view as the fields of view from which the above-described tissue photographs were obtained was performed and analyzed, whereby the composite compound phases in which, in the Ti compound phase, the content ratio of the element M to the total of the Ti element and the element M (atomic ratio M/(Ti+M)) was 0.10 or more, and the Ti compound phase other than the composite compound phases, in which the content ratio was less than 0.10, were specified. From the occupied area of each phase with respect to the occupied area of the binder phase, the content ratio X1 (area %) of the composite compound phase and the content ratio (area %) of the Ti compound phase other than the composite compound phase based on 100 area % in total of the binder phase were calculated. The average value of the content ratios obtained from the analyses of the 20 fields of view was regarded as the content ratios of each sample.

Furthermore, analysis was performed on the tissue photographs of the same fields of view as described above with commercially available image analysis software, and the occupied area of the binder phase and the occupied area of the composite compound phase within a range from the interface between cBN and the binder phase to a distance of 300 nm toward the binder phase were obtained, respectively, and the content ratio X2 (area %) of the composite compound phase based on 100 area % in total of the binder phase in the range was calculated. The average value of the content ratios obtained from the analyses of the 20 fields of view was regarded as the content ratios of each sample. The magnitude relationship between the content ratio X1 and the content ratio X2 was confirmed from the obtained values, and the ratio (X2/X1) of the content ratio X2 to the content ratio X1 was calculated.

The content ratio (atomic ratio M/(Ti+M)) of the element M to the total content ratio of the Ti element and the element M in the composite compound phase was calculated as follows. First, arbitrary points were selected on the compound phase in the same fields of view as the fields of view from which the above-described tissue photographs were obtained, and point analyses by EDS were performed. The point analyses were performed on points at the centers of the fields of view after the fields of views were magnified so that the composite compound phase was present at the center of the field of view and occupied 80% or more of the area of the entire field of view. The point analysis was performed at one point per field of view, and the content ratio of the element M to the total content ratios of the Ti element and the element M (atomic ratio M/(Ti+M)) were calculated from the obtained results. The average of the content ratios obtained from the point analyses at a total of 20 points in the 20 fields of view was regarded as the average value of the M/(Ti+M) of each sample. In addition, the type of the element M was specified from the obtained result.

The content ratio (atomic ratio) of the C element to the total content ratio of the C element and the N element in the composite compound phase was calculated as follows. The result of a point analysis performed to obtain the content ratio of the element M to the total content ratio of the Ti element and the element M (atomic ratio M/(Ti+M)) was analyzed, and the content ratio (atomic ratio) of the C element to the total content ratio of the C element and the N element was calculated. The average value of the content ratios obtained from the point analyses at a total of 20 points in the 20 fields of view was regarded as the content ratios of each sample. In addition, in a case where the content ratio of the C element to the total content ratio of the C element and the N element was 0.2 or less, the composite compound phase was regarded as a nitride containing the Ti element and the element M ((Ti,M)N), in a case where the content ratio was more than 0.2 to less than 0.8, the composite compound phase was regarded as a carbonitride containing the Ti element and the element M ((Ti,M)(C,N)), and in a case where the content ratio was 0.8 or more, the composite compound phase was regarded as a carbide containing the Ti element and the element M ((Ti,M)C).

The content ratio (atomic ratio) of the C element to the total content ratio of the C element and the N element in the Ti compound phase other than the composite compound phase was calculated as follows. First, the result of the mapping analysis of the same fields of view as the fields of views from which the above-described tissue photographs were obtained was analyzed, and a region in which the atomic ratio M/(Ti+M)) was less than 0.10 and the content ratio (atomic ratio) of the B element was less than 0.05 was specified. Arbitrary points on the specified region were selected, and point analysis by EDS was performed. The point analyses were performed on points at the centers of the fields of view after the fields of views were magnified so that the specified region was present at the center of the field of view and occupied 80% or more of the area of the entire field of view. The point analysis was performed at one point per field of view, and the content ratio (atomic ratios) of the C element to the total content ratio of the C element and the N element were calculated from the obtained results. The average of the content ratios obtained from the point analyses at a total of 20 points in the 20 fields of view was regarded as the content ratios of each sample. In addition, in a case where the content ratio of the C element to the total content ratio of the C element and the N element was 0.2 or less, the specified region was regarded as TiN, in a case where the content ratio was more than 0.2 and less than 0.8, the specified region was regarded as TiCN, and in a case where the content ratio was 0.8 or more, the specified region was regarded as TiC. The reason for the region in which the content ratio (atomic ratio) of the B element was less than 0.05 being selected as the target is that TiB₂ identified by the X-ray diffraction measurement was excluded from the analytical points.

The mirror-polished surface of the cBN sintered body in the analysis with the SEM image and the analysis by EDS is a cross section of the cBN sintered body obtained by mirror-polishing the surface or arbitrary cross section of the cBN sintered body. The mirror-polished surface of the cBN sintered body was obtained by polishing using a diamond paste.

The results obtained above are collectively shown in Tables 4 to 6.

Furthermore, the area of the composite compound particles in the cross-sectional structure was obtained by image analysis of the above-described tissue photograph, and the diameter of a circle having the same area as the area thereto was adopted as the particle diameter of the composite compound phase. The area-based average value of the particle sizes of the composite compound phase present in the tissue photograph was calculated. The average value of values obtained from the analyses of the 20 fields of view was obtained as the average grain size of the composite compound phase of each sample. These measurement results are shown in Table 6.

TABLE 4

| | Cubic Boron Nitride Sintered Body | | | | | | | |
|---|---|---|---|---|---|---|---|---|
| | | Binder Phase | | | | | | |
| | cBN | | Al Compound Phase | | Ti Compound Phase | | | |
| | Content | Content | | Content | | Content | Other Phase | |
| | Ratio | Ratio | | Ratio | | Ratio | | Ratio |
| Sample No. | (Area %) | (Area %) | Composition | (Area %) | Composition | (Area %) | Composition | (Area %) |
| Invention | 30.0 | 70.0 | Al₂O₃ | 7.1 | TiC, (Ti, M)C, TiB₂ | 92.9 | — | — |
| Sample 1 | | | | | | | | |
| Invention | 15.0 | 85.0 | Al₂O₃ | 7.6 | TiC, (Ti, M)C, TiB₂ | 92.4 | — | — |
| Sample 2 | | | | | | | | |
| Invention | 25.0 | 75.0 | Al₂O₃ | 7.3 | TiC, (Ti, M)C, TiB₂ | 92.7 | — | — |
| Sample 3 | | | | | | | | |
| Invention | 50.0 | 50.0 | Al₂O₃ | 8.0 | TiC, (Ti, M)C, TiB₂ | 92.0 | — | — |
| Sample 4 | | | | | | | | |
| Invention | 60.0 | 40.0 | Al₂O₃ | 7.5 | TiC, (Ti, M)C, TiB₂ | 92.5 | — | — |
| Sample 5 | | | | | | | | |
| Invention | 30.0 | 70.0 | Al₂O₃ | 2.1 | TiC, (Ti, M)C, TiB₂ | 97.9 | — | — |
| Sample 6 | | | | | | | | |
| Invention | 30.0 | 70.0 | Al₂O₃ | 5.0 | TiC, (Ti, M)C, TiB₂ | 95.0 | — | — |
| Sample 7 | | | | | | | | |
| Invention | 30.0 | 70.0 | Al₂O₃ | 12.1 | TiC, (Ti, M)C, TiB₂ | 87.9 | — | — |
| Sample 8 | | | | | | | | |
| Invention | 30.0 | 70.0 | Al₂O₃, AlN | 17.9 | TiC, (Ti, M)C, TiB₂ | 82.1 | — | — |
| Sample 9 | | | | | | | | |
| Invention | 30.0 | 70.0 | Al₂O₃ | 7.1 | TiC, (Ti, M)C, TiB₂ | 92.9 | — | — |
| Sample 10 | | | | | | | | |
| Invention | 30.0 | 70.0 | Al₂O₃ | 7.1 | TiC, (Ti, M)C, TiB₂ | 92.9 | — | — |
| Sample 11 | | | | | | | | |
| Invention | 30.0 | 70.0 | Al₂O₃ | 7.1 | TiC, (Ti, M)C, TiB₂ | 92.9 | — | — |
| Sample 12 | | | | | | | | |
| Invention | 30.0 | 70.0 | Al₂O₃ | 7.1 | TiC, (Ti, M)C, TiB₂ | 92.9 | — | — |
| Sample 13 | | | | | | | | |
| Invention | 20.0 | 80.0 | Al₂O₃ | 7.5 | TiC, (Ti, M)C, TiB₂ | 92.5 | — | — |
| Sample 14 | | | | | | | | |
| Invention | 20.0 | 80.0 | Al₂O₃ | 7.5 | TiC, (Ti, M)C, TiB₂ | 92.5 | — | — |
| Sample 15 | | | | | | | | |
| Invention | 20.0 | 80.0 | Al₂O₃ | 7.5 | TiC, (Ti, M)C, TiB₂ | 92.5 | — | — |
| Sample 16 | | | | | | | | |
| Invention | 55.0 | 45.0 | Al₂O₃ | 7.8 | TiC, (Ti, M)C, TiB₂ | 92.2 | — | — |
| Sample 17 | | | | | | | | |
| Invention | 55.0 | 45.0 | Al₂O₃ | 7.8 | TiC, (Ti, M)C, TiB₂ | 92.2 | — | — |
| Sample 18 | | | | | | | | |
| Invention | 30.0 | 70.0 | Al₂O₃ | 7.1 | TiC, (Ti, M)C, TiB₂ | 92.9 | — | — |
| Sample 19 | | | | | | | | |
| Invention | 30.0 | 70.0 | Al₂O₃ | 7.1 | TiC, (Ti, M)C, TiB₂ | 92.9 | — | — |
| Sample 20 | | | | | | | | |
| Invention | 30.0 | 70.0 | Al₂O₃ | 7.1 | TiC, (Ti, M)C, TiB₂ | 92.9 | — | — |
| Sample 21 | | | | | | | | |
| Invention | 30.0 | 70.0 | Al₂O₃ | 7.1 | TiC, (Ti, M)C, TiB₂ | 92.9 | — | — |
| Sample 22 | | | | | | | | |
| Invention | 30.0 | 70.0 | Al₂O₃ | 7.1 | TiC, (Ti, M)C, TiB₂ | 92.9 | — | — |
| Sample 23 | | | | | | | | |
| Invention | 30.0 | 70.0 | Al₂O₃ | 7.1 | TiC, (Ti, M)C, TiB₂ | 92.9 | — | — |
| Sample 24 | | | | | | | | |
| Invention | 30.0 | 70.0 | Al₂O₃ | 7.1 | TiC, (Ti, M)C, TiB₂ | 92.9 | — | — |
| Sample 25 | | | | | | | | |
| Invention | 30.0 | 70.0 | Al₂O₃ | 7.1 | TiN, (Ti, M)N, TiB₂ | 92.9 | — | — |
| Sample 26 | | | | | | | | |
| Invention | 30.0 | 70.0 | Al₂O₃ | 7.1 | Ti(C, N), (Ti, M)C, TiB₂ | 92.9 | — | — |
| Sample 27 | | | | | | | | |
| Invention | 30.0 | 70.0 | Al₂O₃ | 7.1 | TiN, (Ti, M)C, TiB₂ | 92.9 | — | — |
| Sample 28 | | | | | | | | |
| Invention | 30.0 | 70.0 | Al₂O₃ | 7.1 | TiC, (Ti, M)C, TiB₂ | 87.3 | Ni | 5.6 |
| Sample 29 | | | | | | | | |
| Invention | 30.0 | 70.0 | Al₂O₃ | 7.1 | TiC, (Ti, M)C, TiB₂ | 87.3 | Co | 5.6 |
| Sample 30 | | | | | | | | |
| Comparative | 5.0 | 95.0 | Al₂O₃ | 7.4 | TiC, (Ti, M)C, TiB₂ | 92.6 | — | — |
| Sample 1 | | | | | | | | |
| Comparative | 5.0 | 95.0 | Al₂O₃ | 7.4 | TiC, (Ti, M)C, TiB₂ | 92.6 | — | — |
| Sample 2 | | | | | | | | |
| Comparative | 5.0 | 95.0 | Al₂O₃ | 7.4 | TiC, (Ti, M)C, TiB₂ | 92.6 | — | — |
| Sample 3 | | | | | | | | |
| Comparative | 70.0 | 30.0 | Al₂O₃ | 6.7 | TiC, (Ti, M)C, TiB₂ | 93.3 | — | — |
| Sample 4 | | | | | | | | |
| Comparative | 70.0 | 30.0 | Al₂O₃ | 6.7 | TiC, (Ti, M)C, TiB₂ | 93.3 | — | — |
| Sample 5 | | | | | | | | |
| Comparative | 30.0 | 70.0 | — | 0.0 | TiC, (Ti, M)C, TiB₂ | 100.0 | — | — |
| Sample 6 | | | | | | | | |
| Comparative | 30.0 | 70.0 | Al₂O₃, AlN | 25.0 | TiC, (Ti, M)C, TiB₂ | 75.0 | — | — |
| Sample 7 | | | | | | | | |
| Comparative | 30.0 | 70.0 | Al₂O₃ | 7.1 | TiC, (Ti, M)C, TiB₂ | 92.9 | — | — |
| Sample 8 | | | | | | | | |
| Comparative | 30.0 | 70.0 | Al₂O₃ | 7.1 | TiC, (Ti, M)C, TiB₂ | 92.9 | — | — |
| Sample 9 | | | | | | | | |
| Comparative | 20.0 | 80.0 | Al₂O₃ | 7.5 | TiC, TiB₂ | 92.5 | — | — |
| Sample 10 | | | | | | | | |

TABLE 5

| | Binder Phase | | | | |
|---|---|---|---|---|---|
| | Ti Compound Phase | | | | |
| | Other than | | | | |
| | Composite | | | | |
| | Compound | | | | |
| | Phase | Composite Compound Phase | | | |
| | Content | Content | Content | Relationship | |
| | Ratio | Ratio | Ratio | between X1 | Ratio |
| Sample No. | (Area %) | X1(Area %) | X2(Area %) | and X2 | (X2/X1) |
| Invention | 82.9 | 10.0 | 15.0 | X1 < X2 | 1.50 |
| Sample 1 | | | | | |
| Invention | 82.4 | 10.0 | 14.8 | X1 < X2 | 1.48 |
| Sample 2 | | | | | |
| Invention | 82.7 | 10.0 | 15.2 | X1 < X2 | 1.52 |
| Sample 3 | | | | | |
| Invention | 82.0 | 10.0 | 15.1 | X1 < X2 | 1.51 |
| Sample 4 | | | | | |
| Invention | 82.5 | 10.0 | 15.3 | X1 < X2 | 1.53 |
| Sample 5 | | | | | |
| Invention | 88.6 | 9.3 | 13.9 | X1 < X2 | 1.50 |
| Sample 6 | | | | | |
| Invention | 85.7 | 9.3 | 14.0 | X1 < X2 | 1.51 |
| Sample 7 | | | | | |
| Invention | 78.6 | 9.3 | 13.9 | X1 < X2 | 1.50 |
| Sample 8 | | | | | |
| Invention | 71.4 | 10.7 | 15.8 | X1 < X2 | 1.47 |
| Sample 9 | | | | | |
| Invention | 82.9 | 10.0 | 11.6 | X1 < X2 | 1.16 |
| Sample 10 | | | | | |
| Invention | 82.9 | 10.0 | 13.1 | X1 < X2 | 1.31 |
| Sample 11 | | | | | |
| Invention | 82.9 | 10.0 | 17.8 | X1 < X2 | 1.78 |
| Sample 12 | | | | | |
| Invention | 82.9 | 10.0 | 19.7 | X1 < X2 | 1.97 |
| Sample 13 | | | | | |
| Invention | 90.0 | 2.5 | 4.5 | X1 < X2 | 1.78 |
| Sample 14 | | | | | |
| Invention | 88.7 | 3.8 | 6.2 | X1 < X2 | 1.64 |
| Sample 15 | | | | | |
| Invention | 86.2 | 6.3 | 9.7 | X1 < X2 | 1.55 |
| Sample 16 | | | | | |
| Invention | 73.3 | 18.9 | 27.4 | X1 < X2 | 1.45 |
| Sample 17 | | | | | |
| Invention | 62.2 | 30.0 | 41.4 | X1 < X2 | 1.38 |
| Sample 18 | | | | | |
| Invention | 82.9 | 10.0 | 20.5 | X1 < X2 | 2.05 |
| Sample 19 | | | | | |
| Invention | 82.9 | 10.0 | 18.1 | X1 < X2 | 1.81 |
| Sample 20 | | | | | |
| Invention | 82.9 | 10.0 | 13.7 | X1 < X2 | 1.37 |
| Sample 21 | | | | | |
| Invention | 82.9 | 10.0 | 13.7 | X1 < X2 | 1.37 |
| Sample 22 | | | | | |
| Invention | 82.9 | 10.0 | 14.8 | X1 < X2 | 1.48 |
| Sample 23 | | | | | |
| Invention | 82.9 | 10.0 | 15.1 | X1 < X2 | 1.51 |
| Sample 24 | | | | | |
| Invention | 82.9 | 10.0 | 14.6 | X1 < X2 | 1.46 |
| Sample 25 | | | | | |
| Invention | 82.9 | 10.0 | 15.1 | X1 < X2 | 1.51 |
| Sample 26 | | | | | |
| Invention | 82.9 | 10.0 | 14.8 | X1 < X2 | 1.48 |
| Sample 27 | | | | | |
| Invention | 82.9 | 10.0 | 15.2 | X1 < X2 | 1.52 |
| Sample 28 | | | | | |
| Invention | 77.3 | 10.0 | 15.1 | X1 < X2 | 1.51 |
| Sample 29 | | | | | |
| Invention | 77.3 | 10.0 | 15.1 | X1 < X2 | 1.51 |
| Sample 30 | | | | | |
| Comparative | 82.1 | 10.5 | 15.4 | X1 < X2 | 1.46 |
| Sample 1 | | | | | |
| Comparative | 82.1 | 10.5 | 23.6 | X1 < X2 | 2.36 |
| Sample 2 | | | | | |
| Comparative | 82.6 | 10.0 | 21.8 | X1 < X2 | 2.26 |
| Sample 3 | | | | | |
| Comparative | 83.3 | 10.0 | 15.2 | X1 < X2 | 1.52 |
| Sample 4 | | | | | |
| Comparative | 51.7 | 41.6 | 53.2 | X1 < X2 | 1.28 |
| Sample 5 | | | | | |
| Comparative | 90.0 | 10.0 | 14.9 | X1 < X2 | 1.49 |
| Sample 6 | | | | | |
| Comparative | 65.7 | 9.3 | 14.1 | X1 < X2 | 1.52 |
| Sample 7 | | | | | |
| Comparative | 82.9 | 10.0 | 9.9 | X1 > X2 | 0.99 |
| Sample 8 | | | | | |
| Comparative | 82.9 | 10.0 | 9.4 | X1 > X2 | 0.94 |
| Sample 9 | | | | | |
| Comparative | 92.5 | 0.0 | — | — | — |
| Sample 10 | | | | | |

TABLE 6

| | Composite Compound Phase | | |
|---|---|---|---|
| | | Average Value | Average Grain |
| Sample No. | Element M | of M/(Ti + M) | Size(μm) |
| Invention Sample 1 | W | 0.38 | 1.6 |
| Invention Sample 2 | W | 0.37 | 1.6 |
| Invention Sample 3 | W | 0.41 | 1.6 |
| Invention Sample 4 | W | 0.39 | 1.6 |
| Invention Sample 5 | W | 0.38 | 1.6 |
| Invention Sample 6 | W | 0.37 | 1.6 |
| Invention Sample 7 | W | 0.39 | 1.6 |
| Invention Sample 8 | W | 0.40 | 1.6 |
| Invention Sample 9 | W | 0.41 | 1.6 |
| Invention Sample 10 | W | 0.38 | 2.8 |
| Invention Sample 11 | W | 0.39 | 2.4 |
| Invention Sample 12 | W | 0.37 | 0.8 |
| Invention Sample 13 | W | 0.40 | 0.6 |
| Invention Sample 14 | W | 0.36 | 1.0 |
| Invention Sample 15 | W | 0.37 | 1.0 |
| Invention Sample 16 | W | 0.37 | 1.6 |
| Invention Sample 17 | W | 0.41 | 2.0 |
| Invention Sample 18 | W | 0.41 | 2.0 |
| Invention Sample 19 | W | 0.11 | 0.8 |
| Invention Sample 20 | W | 0.17 | 1.0 |
| Invention Sample 21 | W | 0.48 | 1.0 |
| Invention Sample 22 | W | 0.57 | 1.0 |
| Invention Sample 23 | W, Ta | 0.38 | 1.6 |
| Invention Sample 24 | Mo | 0.55 | 1.0 |
| Invention Sample 25 | Nb | 0.56 | 1.0 |
| Invention Sample 26 | Zr | 0.54 | 1.0 |
| Invention Sample 27 | W | 0.38 | 1.6 |
| Invention Sample 28 | W | 0.38 | 1.6 |
| Invention Sample 29 | W | 0.39 | 1.6 |
| Invention Sample 30 | W | 0.39 | 1.6 |
| Comparative Sample 1 | W | 0.39 | 1.6 |
| Comparative Sample 2 | W | 0.40 | 0.6 |
| Comparative Sample 3 | W | 0.40 | 0.8 |
| Comparative Sample 4 | W | 0.39 | 1.6 |
| Comparative Sample 5 | W | 0.41 | 2.0 |
| Comparative Sample 6 | W | 0.38 | 1.6 |
| Comparative Sample 7 | W | 0.38 | 1.6 |
| Comparative Sample 8 | W | 0.39 | 1.6 |
| Comparative Sample 9 | W | 0.39 | 3.2 |
| Comparative Sample 10 | — | — | — |

### [Production of Cutting Tool]

The cBN sintered body obtained above was cut using a wire electric discharge machine according to a tool shape with an insert shape defined by the ISO standard CNGA120408. The cut cBN sintered body was joined to a base metal made of a cemented carbide by brazing. The brazed tool was honed to obtain a cutting tool.

On the obtained cutting tool as samples, the following cutting test and evaluation were performed.

### [Cutting Test]

Work material: SCM435H (HRC58),
Work material shape: A round bar with two grooves provided at an equal interval on the outer peripheral surface,
Processing method: External turning,
Cutting speed: 200 m/min,
Feed: 0.10 mm/rev,
Cut depth: 0.20 mm,
Coolant: Used (water-soluble coolant),
Evaluation item: When the flank wear width of the tool reached 0.15 mm or the tool fractured, the tool was regarded as reaching the tool life, and the processing time taken to reach the tool life was measured. In addition, the damage morphology of the sample for which the flank wear width of the tool reached 0.15 mm and reached the tool life was regarded as “normal wear,” and the damage morphology of the sample for which the tool fractured and reached the tool life was regarded as “fracture.”

The results of the test are shown in Table 7.

TABLE 7

Cutting Test

| | Tool Life | Damage |
|---|---|---|
| Sample No. | (minutes) | Morphology |
| Invention Sample 1 | 24 | Normal Wear |
| Invention Sample 2 | 17 | Normal Wear |
| Invention Sample 3 | 22 | Normal Wear |
| Invention Sample 4 | 21 | Normal Wear |
| Invention Sample 5 | 17 | Normal Wear |
| Invention Sample 6 | 18 | Normal Wear |
| Invention Sample 7 | 22 | Normal Wear |
| Invention Sample 8 | 20 | Normal Wear |
| Invention Sample 9 | 16 | Normal Wear |
| Invention Sample 10 | 17 | Normal Wear |
| Invention Sample 11 | 20 | Normal Wear |
| Invention Sample 12 | 20 | Normal Wear |
| Invention Sample 13 | 16 | Normal Wear |
| Invention Sample 14 | 16 | Normal Wear |
| Invention Sample 15 | 18 | Normal Wear |
| Invention Sample 16 | 20 | Normal Wear |
| Invention Sample 17 | 19 | Normal Wear |
| Invention Sample 18 | 16 | Normal Wear |
| Invention Sample 19 | 17 | Normal Wear |
| Invention Sample 20 | 19 | Normal Wear |
| Invention Sample 21 | 18 | Normal Wear |
| Invention Sample 22 | 18 | Normal Wear |
| Invention Sample 23 | 26 | Normal Wear |
| Invention Sample 24 | 19 | Normal Wear |
| Invention Sample 25 | 20 | Normal Wear |
| Invention Sample 26 | 18 | Normal Wear |
| Invention Sample 27 | 23 | Normal Wear |
| Invention Sample 28 | 20 | Normal Wear |
| Invention Sample 29 | 24 | Normal Wear |
| Invention Sample 30 | 24 | Normal Wear |
| Comparative Sample 1 | 10 | Fracture |
| Comparative Sample 2 | 7 | Fracture |
| Comparative Sample 3 | 8 | Fracture |
| Comparative Sample 4 | 13 | Normal Wear |
| Comparative Sample 5 | 10 | Fracture |
| Comparative Sample 6 | 7 | Fracture |
| Comparative Sample 7 | 9 | Fracture |
| Comparative Sample 8 | 13 | Fracture |
| Comparative Sample 9 | 11 | Fracture |
| Comparative Sample 10 | 9 | Fracture |

From the results shown in Table 7, it was found that the cutting tools for which the cBN sintered body of an invention sample was used was superior to the cutting tools for which the cBN sintered body of a comparative sample was used in wear resistance and fracture resistance and had a longer tool life.

### Example 2

Next, as shown in Table 8, an ion bombardment treatment was performed on the surfaces of the cBN sintered bodies of Invention Sample 3, Invention Sample 4, Invention Sample 15, and Invention Sample 17 obtained in Example 1, and then coating layers were formed by an arc ion plating method. In the case of being formed, a first layer and a second layer were formed on the surface of the cBN sintered body in this order. In Invention Samples 32, 38, 42, 46, and 50 in which two compounds were contained in the composition of the first layer, layers of the individual compounds, each layer being 50 nm, were alternately and repeatedly formed to reach an average thickness of the first layer. The respective processing conditions were set as follows. In addition, the compositions and average thicknesses of the coating layers were as shown in Table 8 below.

### [Conditions of Ion Bombardment Treatment]

Base material temperature: 500° C.,
Pressure: An Ar gas atmosphere at 2.7 Pa,
Voltage: −400 V,
Electric current: 40 A,
Time: 30 minutes.

### [Coating Layer Forming Conditions]

Base material temperature: 500° C.,
Pressure: A nitrogen (N₂) gas atmosphere (nitride layer) at 3.0 Pa or a gas mixture atmosphere (carbonitride layer) of a nitrogen (N₂) gas and an acetylene (C₂H₂) gas at 3.0 Pa,
Voltage: −60 V,
Electric current: 120 A.

TABLE 8

| | | Coating Layer | | | | |
|---|---|---|---|---|---|---|
| | | First Layer | | Second Layer | | Average |
| | Cubic Boron | | Average | | Average | Thickness |
| | Nitride | | Thickness | | Thickness | of Whole |
| Sample No. | Sintered Body | Composition | (μm) | Composition | (μm) | (μm) |
| Invention | Invention | TiCN | 1.0 | — | — | 1.0 |
| Sample 31 | Sample 3 | | | | | |
| Invention | Invention | Ti_{0.50}Al_{0.50}N/Ti_{0.33}Al_{0.67}N | 0.5 | — | — | 0.5 |
| Sample 32 | Sample 3 | | | | | |
| Invention | Invention | TiN | 0.2 | Ti_{0.50}Al_{0.50}N | 1.3 | 1.5 |
| Sample 33 | Sample 3 | | | | | |
| Invention | Invention | Ti_{0.50}Al_{0.50}N | 0.2 | TiCN | 1.3 | 1.5 |
| Sample 34 | Sample 3 | | | | | |
| Invention | Invention | TiCN | 5.0 | — | — | 5.0 |
| Sample 35 | Sample 3 | | | | | |
| Invention | Invention | Ti_{0.50}Al_{0.50}N | 3.0 | — | — | 3.0 |
| Sample 36 | Sample 3 | | | | | |
| Invention | Invention | TiN | 0.5 | TiCN | 4.5 | 5.0 |
| Sample 37 | Sample 3 | | | | | |
| Invention | Invention | Ti_{0.50}Al_{0.50}N/Ti_{0.33}Al_{0.67}N | 4.5 | Ti_{0.90}Si_{0.10}N | 0.5 | 5.0 |
| Sample 38 | Sample 3 | | | | | |
| Invention | Invention | TiCN | 1.0 | — | — | 1.0 |
| Sample 39 | Sample 4 | | | | | |
| Invention | Invention | Ti_{0.50}Al_{0.50}N | 6.0 | — | — | 6.0 |
| Sample 40 | Sample 4 | | | | | |
| Invention | Invention | TiN | 0.5 | TiCN | 1.0 | 1.5 |
| Sample 41 | Sample 4 | | | | | |
| Invention | Invention | Ti_{0.50}Al_{0.50}N/Ti_{0.33}Al_{0.67}N | 6.0 | CrN | 0.5 | 6.5 |
| Sample 42 | Sample 4 | | | | | |
| Invention | Invention | TiCN | 1.0 | — | — | 1.0 |
| Sample 43 | Sample 15 | | | | | |
| Invention | Invention | Ti_{0.50}Al_{0.50}N | 6.0 | — | — | 6.0 |
| Sample 44 | Sample 15 | | | | | |
| Invention | Invention | TiN | 0.5 | TiCN | 1.0 | 1.5 |
| Sample 45 | Sample 15 | | | | | |
| Invention | Invention | Ti_{0.50}Al_{0.50}N/Ti_{0.33}Al_{0.67}N | 6.0 | NbN | 0.5 | 6.5 |
| Sample 46 | Sample 15 | | | | | |
| Invention | Invention | TiCN | 1.0 | — | — | 1.0 |
| Sample 47 | Sample 17 | | | | | |
| Invention | Invention | Ti_{0.50}Al_{0.50}N | 6.0 | — | — | 6.0 |
| Sample 48 | Sample 17 | | | | | |
| Invention | Invention | TiN | 0.5 | TiCN | 1.0 | 1.5 |
| Sample 49 | Sample 17 | | | | | |
| Invention | Invention | Ti_{0.50}Al_{0.50}N/Ti_{0.33}Al_{0.67}N | 6.0 | Ti_{0.50}Al_{0.50}N | 0.5 | 6.5 |
| Sample 50 | Sample 17 | | | | | |

A cutting test was performed in the same manner as in Example 1 using the obtained coated cBN sintered bodies, and the invention samples were evaluated. The results are shown in Table 9.

TABLE 9

Cutting Test

| | Tool Life | Damage |
|---|---|---|
| Sample No. | (minutes) | Morphology |
| Invention Sample 31 | 26 | Normal Wear |
| Invention Sample 32 | 24 | Normal Wear |
| Invention Sample 33 | 25 | Normal Wear |
| Invention Sample 34 | 27 | Normal Wear |
| Invention Sample 35 | 30 | Normal Wear |
| Invention Sample 36 | 28 | Normal Wear |
| Invention Sample 37 | 31 | Normal Wear |
| Invention Sample 38 | 32 | Normal Wear |
| Invention Sample 39 | 24 | Normal Wear |
| Invention Sample 40 | 28 | Normal Wear |
| Invention Sample 41 | 26 | Normal Wear |
| Invention Sample 42 | 28 | Normal Wear |
| Invention Sample 43 | 23 | Normal Wear |
| Invention Sample 44 | 27 | Normal Wear |
| Invention Sample 45 | 24 | Normal Wear |
| Invention Sample 46 | 27 | Normal Wear |
| Invention Sample 47 | 27 | Normal Wear |
| Invention Sample 48 | 31 | Normal Wear |
| Invention Sample 49 | 26 | Normal Wear |
| Invention Sample 50 | 31 | Normal Wear |

It was found from the results shown in Table 9 that the coated cBN sintered bodies having the coating layer formed on the surface (Invention Samples 31 to 50) are further superior to the cBN sintered bodies having no coating layers formed therein (Invention Samples 3, 4, 15, and 17) in wear resistance and fracture resistance and have a longer tool life.

### INDUSTRIAL APPLICABILITY

Since the cubic boron nitride sintered body and the coated cubic boron nitride sintered body according to the present invention are excellent in wear resistance and fracture resistance and are thereby capable of extending the tool life more than ever and are thus highly industrially applicable in terms of those.

What is claimed is:

1. A cubic boron nitride sintered body comprising:
cubic boron nitride; and
a binder phase,
wherein when a cross-sectional structure of the cubic boron nitride sintered body is observed, a content ratio of the cubic boron nitride is 10.0 area % or more and 60.0 area % or less, and a content ratio of the binder phase is 40.0 area % or more and 90.0 area % or less, based on 100 area % in total of the cubic boron nitride sintered body,
the binder phase comprises an Al compound phase and a Ti compound phase,
the Al compound phase comprises a compound of Al and at least one element selected from the group consisting of C, N, O, and B,
the Ti compound phase comprises at least one selected from the group consisting of a compound of Ti and at least one element selected from the group consisting of C, N, O, and B and a compound of Ti, at least one element selected from the group consisting of V, Cr, Zr, Nb, Mo, Hf, Ta, and W, and at least one element selected from the group consisting of C, N, O, and B,
the Ti compound phase comprises a composite compound phase,
the composite compound phase comprises at least one selected from the group consisting of a carbide, a nitride, and a carbonitride each comprising Ti and at least one element selected from the group consisting of V, Cr, Zr, Nb, Mo, Hf, Ta, and W,
in the cross-sectional structure, a content ratio of the Al compound phase is more than 0.0 area % and 20.0 area % or less, and a content ratio of the Ti compound phase is 80.0 area % or more and less than 100.0 area %, based on 100 area % in total of the binder phase, and
in the cross-sectional structure, when a content ratio of the composite compound phase based on 100 area % in total of the binder phase is indicated by a content ratio X1, and a content ratio of the composite compound phase based on 100 area % in total of the binder phase in a range from an interface between the cubic boron nitride and the binder phase to a distance of 300 nm toward the binder phase is indicated by a content ratio X2, the content ratio X2 is larger than the content ratio X1.

2. The cubic boron nitride sintered body according to claim 1, wherein a ratio of the content ratio X2 to the content ratio X1 is 1.10 or more and 2.10 or less.

3. The cubic boron nitride sintered body according to claim 1, wherein the content ratio X1 is 2.0 area % or more and 30.0 area % or less.

4. The cubic boron nitride sintered body according to claim 1, wherein an average grain size of the composite compound phase is 0.8 μm or more and 3.0 μm or less.

5. The cubic boron nitride sintered body according to claim 1, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

6. The cubic boron nitride sintered body according to claim 3, wherein the content ratio X2 is 3.0 area % or more and 45.0 area % or less.

7. A coated cubic boron nitride sintered body comprising:
the cubic boron nitride sintered body according to claim 1; and a coating layer formed on a surface of the cubic boron nitride sintered body,
wherein the coating layer is a single layer or a lamination of two or more layers comprising at least one element selected from the group consisting of Ti, Zr, Hf, V, Nb, Ta, Cr, Mo, W, Al, and Si and at least one element selected from the group consisting of C, N, O, and B, and
an average thickness of a whole of the coating layer is 0.5 μm or more and 8.0 μm or less.

8. A tool comprising:
the cubic boron nitride sintered body according to claim 1.

9. A tool comprising:
the coated cubic boron nitride sintered body according to claim 7.

10. The cubic boron nitride sintered body according to claim 2, wherein the content ratio X1 is 2.0 area % or more and 30.0 area % or less.

11. The cubic boron nitride sintered body according to claim 2, wherein an average grain size of the composite compound phase is 0.8 μm or more and 3.0 μm or less.

12. The cubic boron nitride sintered body according to claim 6, wherein an average grain size of the composite compound phase is 0.8 μm or more and 3.0 μm or less.

13. The cubic boron nitride sintered body according to claim 10, wherein an average grain size of the composite compound phase is 0.8 μm or more and 3.0 μm or less.

14. The cubic boron nitride sintered body according to claim 2, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

15. The cubic boron nitride sintered body according to claim 11, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

16. The cubic boron nitride sintered body according to claim 6, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

17. The cubic boron nitride sintered body according to claim 12, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

18. The cubic boron nitride sintered body according to claim 10, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

19. The cubic boron nitride sintered body according to claim 13, wherein in the composite compound phase, a content ratio of at least one element selected from the group consisting of V, Cr, Zr, Nb, Mo, Hf, Ta, and W to a total content ratio of Ti and at least one element selected from the group consisting of V, Cr, Zr, Nb, Mo, Hf, Ta, and W is 0.10 or more and 0.60 or less in terms of atomic ratio.

20. The cubic boron nitride sintered body according to claim 19, wherein the content ratio X2 is 3.0 area % or more and 45.0 area % or less.
